(19) United States
(12) Patent Application Publication
(10) Pub. No.: US 2026/0054181 A1
(43) Pub. Date: Feb. 26, 2026

(54) INFORMATION PROCESSING SYSTEM THAT EMBEDS ELECTRONIC WATERMARK IN GAME IMAGE, NON-TRANSITORY STORAGE MEDIUM ENCODED WITH COMPUTER READABLE PROGRAM, INFORMATION PROCESSING APPARATUS, AND INFORMATION PROCESSING METHOD

(71) Applicant: NINTENDO CO., LTD., Kyoto-shi (JP)

(72) Inventor: Ryohei FUJITA, Kyoto-shi (JP)

(21) Appl. No.: 19/376,259

(22) Filed: Oct. 31, 2025

Related U.S. Application Data
(63) Continuation of application No. PCT/JP2023/017145, filed on May 2, 2023.

(51) Int. Cl. A63F 13/77

(52) U.S. Cl. CPC A63F 13/77

(57) ABSTRACT

An information processing system includes one or more processors and one or more memories storing instructions that when executed, cause the information processing system to perform operations including accepting an operation input from a player, performing game processing corresponding to the accepted operation input, and generating, for a game image based on the game processing, an electronically watermarked game image in which information on the game processing corresponding at least to the operation input is embedded by electronic watermark.

This nonprovisional application claims priority on and is a continuation of International Patent Application PCT/JP2023/017145 filed with the Japan Patent Office on May 2, 2023, the entire contents of which are hereby incorporated by reference.

### FIELD

The present disclosure relates to an information processing system and particularly to a technique to embed an electronic watermark in a game image.

### BACKGROUND AND SUMMARY

An electronic watermark has conventionally been embedded in a game image. For example, a function is provided in the game processing that allows for creation of a snap shot of a virtual environment shown in the game image, and there is a technique to use electronic watermark for incorporating information such as a time stamp, a user ID, or a serial number of an apparatus in the snap shot.

According to the prior technique, on the other hand, what kind of game processing has been performed cannot be known based on information embedded in a game image by electronic watermark.

According to one example of the present disclosure, an information processing system includes one or more processors and one or more memories storing instructions that when executed, cause the information processing system to perform operations including accepting an operation input from a player, performing game processing corresponding to the accepted operation input, and generating, for a game image based on the game processing, an electronically watermarked game image in which information on the game processing corresponding at least to the operation input is embedded by electronic watermark. According to this configuration, the electronically watermarked game image in which information on game processing is embedded by electronic watermark is generated. Therefore, what kind of game processing has been performed can be known from the electronically watermarked game image.

In the exemplary embodiment, the information on the game processing does not include information that specifies the player. According to this configuration, not information that specifies the player but the information on the game processing is extracted from the game image. Therefore, what kind of game processing has been performed can be known from the electronically watermarked game image.

In the exemplary embodiment, the information processing system further includes a server and a communication unit configured to communicate with the server. The game processing includes predetermined game processing associated with an identifier that is different each time the game processing is performed. The generating the electronically watermarked game image generates, for a game image based on the predetermined game processing, an electronically watermarked game image in which the identifier is embedded by electronic watermark. The communication unit is configured to transmit information on the predetermined game processing corresponding to the identifier to the server. According to this configuration, the electronically watermarked game image in which the identifier is embedded by electronic watermark is generated and information on a game event corresponding to the identifier is transmitted to the server. Therefore, if the identifier can be read from the electronically watermarked game image, the information on the game event can be obtained and what kind of game processing has been performed can be known from the electronically watermarked game image.

In the exemplary embodiment, information on the predetermined game processing includes information for reproducing the predetermined game processing. According to this configuration, the game event can be reproduced.

In the exemplary embodiment, the information on the game processing corresponding to the operation input includes information on the operation input from the player. According to this configuration, since the information on the operation input from the player can be obtained, the operation input that has lead to the game image can be known and what kind of game processing has been performed can be known from the electronically watermarked game image.

In the exemplary embodiment, the information on the game processing corresponding to the operation input includes at least one of information on a flag of the game processing, a seed value of the game processing, information to be used for determination as to collision of an object controlled in the game processing, and information on a memory of an apparatus configured to perform the game processing. According to this configuration, what kind of game processing has been performed can be known from the electronically watermarked game image, based on the information on the flag of the game processing, the seed value of the game processing, the information to be used for determination as to collision of the object controlled in the game processing, and the information on the memory of the apparatus configured to perform the game processing.

In the exemplary embodiment, the information processing system further includes storing the electronically watermarked game image in accordance with a game image storage instruction from the player. The generating the electronically watermarked game image generates for the game image based on the game processing, when the game image storage instruction is given, the electronically watermarked game image in which the information on the game processing corresponding at least to the operation input is embedded by electronic watermark, and does not generate for the game image based on the game processing, when the game image storage instruction is not given, the electronically watermarked game image in which the information on the game processing corresponding at least to the operation input is embedded by electronic watermark. According to this configuration, when the game image storage instruction is not given, the electronically watermarked game image is not generated and hence processing load imposed on the system can be reduced.

According to another example of the present disclosure, one or more non-transitory storage media having stored therein instructions that, when executed by one or more processors, cause a computer to perform the following processes of accepting an operation input from a player, performing game processing corresponding to the accepted operation input, and generating, for a game image based on the game processing, an electronically watermarked game image in which information on the game processing corresponding at least to the operation input is embedded by electronic watermark. According to this configuration, the electronically watermarked game image in which information on game processing is embedded by electronic watermark is generated. Therefore, what kind of game processing has been performed can be known from the electronically watermarked game image.

According to yet another example of the present disclosure, an information processing apparatus includes accepting an operation input from a player, performing game processing corresponding to the accepted operation input, and generating, for a game image based on the game processing, an electronically watermarked game image in which information on the game processing corresponding at least to the operation input is embedded by electronic watermark. According to this configuration, the electronically watermarked game image in which information on game processing is embedded by electronic watermark is generated. Therefore, what kind of game processing has been performed can be known from the electronically watermarked game image.

According to yet another example of the present disclosure, a computer-implemented method includes accepting an operation input from a player, performing game processing corresponding to the accepted operation input, and generating, for a game image based on the game processing, an electronically watermarked game image in which information on the game processing corresponding at least to the operation input is embedded by electronic watermark. According to this configuration, the electronically watermarked game image in which information on game processing is embedded by electronic watermark is generated. Therefore, what kind of game processing has been performed can be known from the electronically watermarked game image.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 shows an exemplary illustrative non-limiting drawing of a diagram illustrating overview of a configuration of an information processing system 1 according to an embodiment.

FIG. 2 shows an exemplary illustrative non-limiting drawing of a diagram illustrating a functional block of an information processing apparatus 10 according to the embodiment.

FIG. 3 shows an exemplary illustrative non-limiting drawing of a diagram illustrating a functional block of a server 30 according to the embodiment.

FIG. 4 shows an exemplary illustrative non-limiting drawing of a diagram illustrating a game image of an on-line competitive game according to the embodiment.

FIG. 5 shows an exemplary illustrative non-limiting drawing of a flowchart illustrating

processing in an information processing apparatus 10A according to the embodiment.

FIG. 6 shows an exemplary illustrative non-limiting drawing of a flowchart illustrating transmission processing in information processing apparatus 10A according to the embodiment.

FIG. 7 shows an exemplary illustrative non-limiting drawing of a diagram showing exemplary operation data associated with an identifier and time information, the operation data being transmitted to server 30.

### DETAILED DESCRIPTION OF NON-LIMITING EXAMPLE EMBODIMENTS

This embodiment will be described in detail with reference to the drawings. The same or corresponding elements in the drawings have the same reference characters allotted and description thereof will not be repeated.

### [A. Configuration of Information Processing System]

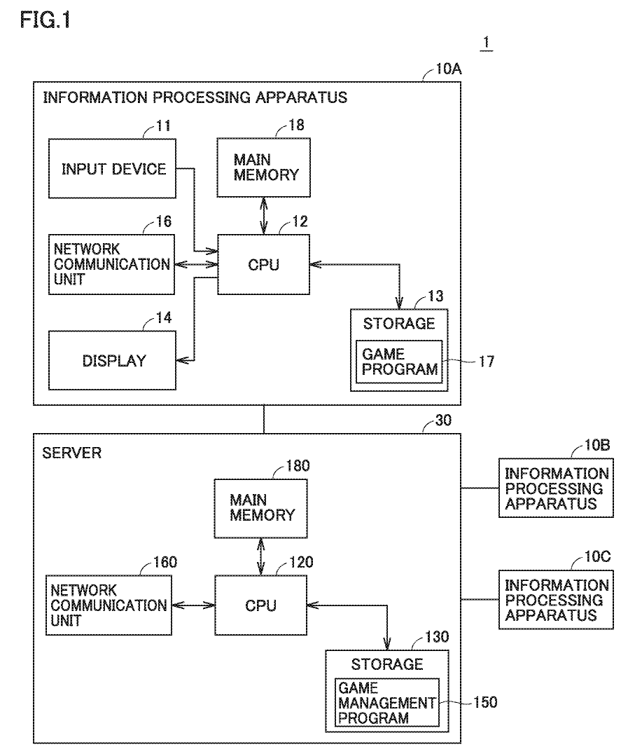

FIG. 1 is a diagram illustrating an overview of a configuration of an information processing system 1 according to an embodiment.

Referring to FIG. 1, information processing system 1 includes a server 30 and a plurality of information processing apparatuses 10A to 10C (which will also collectively be referred to as an information processing apparatus 10 below) configured to communicate with server 30.

The plurality of information processing apparatuses 10A to 10C are identical in configuration to one another, and information processing apparatus 10A will mainly representatively be described in the present example. The plurality of information processing apparatuses 10A to 10C are not limited to three information processing apparatuses, and a plurality of additional information processing apparatuses can also further be provided.

By way of example, a configuration in which information processing apparatus 10A according to the embodiment is implemented as a game device will be described.

Information processing apparatus 10A is any computer. Information processing apparatus 10A may be, for example, a portable (also referred to as mobile) device such as a portable game device, a portable telephone, or a smartphone, a stationary apparatus such as a personal computer or a home game console, or a large apparatus such as an arcade game machine for a commercial purpose.

A hardware configuration of information processing apparatus 10A is outlined below.

Information processing apparatus 10A includes a CPU 12 and a main memory 18. CPU 12 is an information processor configured to perform various types of information processing in information processing apparatus 10. CPU 12 performs the various types of information processing by using main memory 18.

Information processing apparatus 10A includes a storage 13. A game program 17 to be executed in information processing apparatus 10A is stored in storage 13.

For example, a storage embedded in information processing apparatus 10A such as a hard disk or a memory, a storage medium attachable to and removable from information processing apparatus 10A such as an optical disc or a cartridge, or both of a storage and a storage medium as such may be adopted as storage 13. In such a case, an information processing system including information processing apparatus 10A and any storage medium may be configured.

Game program 17 includes computer-readable instructions for performing information processing as will be described later. The program may also include a program that establishes data communication with server 30 and a program that establishes data communication with another information processing apparatus as a part of processing. Details of game program 17 will be described later. Game program 17 may include an operating system, a communication program, or the like in addition to the program configured to perform game processing.

Information processing apparatus 10A includes an input device 11 that accepts an instruction from a user (player), such as an analog stick, a button, or a touch panel. Information processing apparatus 10A includes a display 14 that shows an image generated through information processing. Though not shown, input device 11 may include a button for an instruction to perform a screenshot function to store a game image. Without being limited to the configuration, various input forms and representation forms can be adopted. For example, for input device 11, such a form as capturing a gesture or a motion of the user and accepting the gesture or the motion as an operation input may be adopted.

Information processing apparatus 10A includes a network communication unit 16. Network communication unit 16 may be connected to a not-shown network and may perform processing for data communication with an external apparatus (for example, server 30 or another information processing apparatus).

Information processing apparatus 10A may be implemented by a plurality of apparatuses. For example, information processing apparatus 10A may be implemented by a main body apparatus including CPU 12 and an apparatus including input device 11 and/or display 14, which are separate from each other. For example, in another embodiment, information processing apparatus 10A may be implemented by a main body apparatus and a terminal device including input device 11 and display 14, or by a main body apparatus and an operation apparatus including input device 11. Information processing apparatus 10A may employ a television as a display apparatus, without including display 14.

In another embodiment, at least some of information processing performed in information processing apparatus 10A may be performed as being distributed among a plurality of apparatuses that can communicate over a network (a wide range network and/or a local network). Specifically, server 30 may perform at least some of information processing performed by information processing apparatus 10.

A hardware configuration of server 30 is outlined.

Server 30 includes a CPU 120 and a main memory 180. CPU 120 is an information processor that performs various types of information processing in server 30. CPU 120 performs the various types of information processing by using main memory 180.

Server 30 includes a storage 130. A game management program 150 to be executed in server 30 is stored in storage 130.

For example, a storage embedded in server 30 such as a hard disk or a memory, a storage medium attachable to and removable from server 30 such as an optical disc or a cartridge, or both of a storage and a storage medium as such may be adopted as storage 130. In such a case, a game system representing an exemplary information processing system including server 30 and any storage medium may be configured.

Game management program 150 includes computer-readable instructions for performing information processing as will be described later. The program may also include a program that establishes data communication with information processing apparatuses 10A to 10C and a program that establishes data communication with another information processing apparatus as a part of processing. Game management program 150 may include an operating system, a communication program, or the like in addition to a matching processing program for performing processing for matching users who play against each other, for performing on-line competitive game processing. Any storage (storage medium) accessible by CPU 120 is adopted as storage 130. For example, a storage embedded in server 30 such as a hard disk or a memory, a storage medium attachable to and removable from server 30 such as an optical disc or a cartridge, or both of a storage and a storage medium as such may be adopted as storage 130.

Server 30 includes a network communication unit 160. Network communication unit 160 may be connected to a not-shown network and may perform processing for data communication with information processing apparatuses 10A to 10C.

Server 30 may be implemented by a plurality of apparatuses. In another embodiment, at least some of information processing performed in server 30 may be performed as being distributed among a plurality of other servers that can communicate over a network (a wide range network and/or a local network).

### [B. Functional Configuration of Information Processing Apparatus 10]

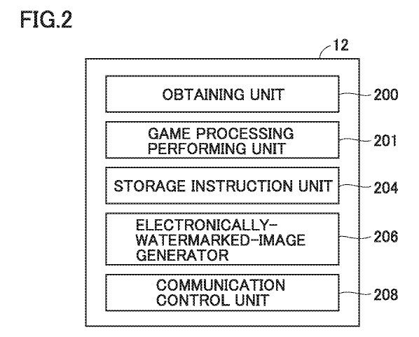

FIG. 2 is a diagram illustrating a functional block of information processing apparatus 10 according to the embodiment. Referring to FIG. 2, CPU 12 of information processing apparatus 10 implements various functional blocks by reading game program 17.

CPU 12 includes an obtaining unit 200, a game processing performing unit 201, a storage instruction unit 204, an electronically-watermarked-image generator 206, and a communication control unit 208.

Obtaining unit 200 obtains operation data indicating an operation input given by a user (player) through input device 11. Obtaining unit 200 obtains operation data or the like inputted to another information processing apparatus 10 by a user (another player) through communication control unit 208.

Game processing performing unit 201 performs game processing. In the present example, by way of example, the game processing performing unit performs game processing for an on-line competitive game against another user. Specifically, the game processing performing unit performs game processing based on operation data obtained by obtaining unit 200, operation data from another user, and the like. Game processing performing unit 201 generates a game image based on the game processing and outputs the game image to display 14.

Storage instruction unit 204 has the game image stored in storage 13 with a screenshot function when it accepts an instruction given by a predetermined operation by the user. In the present example, storage instruction unit 204 has the game image stored in storage 13 in response to pressing of a button for an instruction to perform the screenshot function, which is by way of example of the predetermined operation by the user.

Though an example in which the button for the instruction to perform the screenshot function is pressed is described by way of example, without being limited to pressing of the button, the screenshot function may be performed, for example, by showing a menu in response to an operation by the user and selecting an item corresponding to a screenshot included in the menu.

Specifically, storage instruction unit 204 instructs electronically-watermarked-image generator 206 to generate an electronically watermarked game image and has the electronically watermarked game image stored in storage 13.

Electronically-watermarked-image generator 206 generates for a game image based on game processing, an electronically watermarked game image in which information on game processing corresponding at least to an operation input from the user through input device 11 is embedded by electronic watermark, in accordance with an instruction from storage instruction unit 204.

Storage instruction unit 204 has the electronically watermarked game image stored in storage 13, the electronically watermarked game image being generated by electronically-watermarked-image generator 206.

Communication control unit 208 transmits and receives data such as operation data to and from server 30 through network communication unit 16 and transmits to server 30, the electronically watermarked game image stored in storage 13 as instructed by storage instruction unit 204.

### [C. Functional Configuration of Server 30]

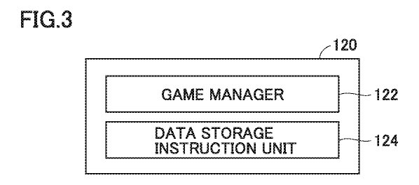

FIG. 3 is a diagram illustrating a functional block of server 30 according to the embodiment. Referring to FIG. 3, CPU 120 of server 30 implements various functional blocks by reading game management program 150.

CPU 120 includes a game manager 122 and a data storage instruction unit 124.

Game manager 122 performs matching processing for matching users who perform on-line competitive game processing. In addition, game manager 122 launches a game event for performing the on-line competitive game processing and transmits an identifier issued for each game event to corresponding information processing apparatus 10 together with a result of matching. For example, in an example where a user A of information processing apparatus 10A and a user B of information processing apparatus 10B perform the on-line competitive game processing, game manager 122 transmits the identifier issued for the launched game event to each of information processing apparatuses 10A and 10B.

With the identifier, the game event can be specified, and with the use of the identifier, data such as operation data is transmitted and received.

Game manager 122 gives an instruction to data storage instruction unit 124 for storing electronically watermarked game images obtained from information processing apparatuses 10A to 10C. Data storage instruction unit 124 has the electronically watermarked game image stored in storage 130 in accordance with the instruction from game manager 122.

### [D. Processing in On-Line Competitive Game]

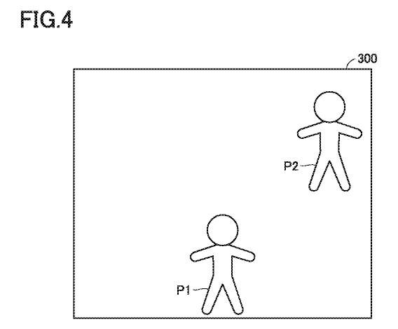

FIG. 4 is a diagram illustrating a game image of an on-line competitive game according to the embodiment.

Referring to FIG. 4, game program 17 according to the embodiment provides an on-line competitive game which is a kind of a match in which a plurality of users can participate. The plurality of users may include one real user and a virtual user provided on a computer. The plurality of users are not limited to two users but may be three or more users, or a plurality of users may form one team and teams play against each other.

By way of example, in the on-line competitive game provided by game program 17, a plurality of users play against each other by operating characters corresponding to them on a game field.

In the on-line competitive game processing, a game image is generated based on operation data of the user obtained by obtaining unit 200 and operation data of another user received through communication control unit 208, and the generated game image is outputted to display 14.

### [E. Processing for Generating Electronically Watermarked Game Image]

In the present example, in accordance with an operation by the user, an electronically watermarked game image in which information on the game processing corresponding at least to the operation input is embedded by electronic watermark is generated for a game image and stored in storage 13. The stored electronically watermarked game image may be shown on display 14 in accordance with an operation by the user.

The electronically watermarked game image stored in storage 13 is transmitted to server 30 in accordance with a further operation by the user. The stored electronically watermarked game image may automatically be transmitted to server 30 without a further operation by the user.

The electronically watermarked game image transmitted to server 30 may be published, for example, to a user in predetermined relation with the user or any number of users, without an operation by the user.

Information on the game processing embedded by electronic watermark may be, for example, information indicating a cause that has caused the game processing. Specifically, the information includes information on the operation input from the user, parameter information of a character operated by the user, flag information, a seed value to be used for generation of a world (stage), and information to be used for determination as to collision (determination as to hitting) of an object.

Alternatively, the information on the game processing embedded by electronic watermark may be, for example, information indicating which game processing has been performed. Specifically, the information includes an identifier indicating a mode of an executed game and an identifier with which matching performed in the game processing for an on-line competitive game can be specified.

The identifier indicating the mode of the executed game may be, for example, information indicating what kind of game has been executed in an application where a plurality of types of games different in rule are executable. Specifically, the identifier may be information indicating whether or not a game is a game in which communication with another user is established or information indicating whether a game is a competitive game played between users or a game where users cooperate with each other.

The identifier with which matching performed in the game processing for the on-line competitive game can be specified may be, for example, an identifier with which the matching can uniquely be specified, the identifier being issued each time of matching in the on-line competitive game.

Alternatively, the information on the game processing embedded by electronic watermark may be information indicating a state of the system that is performing game processing. Specifically, the information includes information on a status of use of a memory or a communication rate of an information terminal that is performing game processing.

In the present example, the information on the game processing does not include information that specifies a user. Specifically, the information does not include such information as a user (player) ID or a serial number of an information processing apparatus main body.

By way of example, image generator 206 generates an electronically watermarked game image based on LSB steganography. LSB steganography refers to embedment of information on game processing by changing a least significant bit of pixel data of a generated game image. For example, 3-bit information on game processing can be embedded in one pixel by embedding data in the least significant bit (LSB) of each of RGB values of the game image.

Information on the game processing embedded based on LSB steganography is obtained by extraction of the least significant bit (LSB) of each of RGB values of pixel data of the electronically watermarked game image.

The electronically watermarked game image based on LSB steganography is the electronically watermarked game image where only the least significant bits (LSBs) of the RGB values have been changed, and it is difficult for a user to identify change of the image. Therefore, information can be embedded without influence on the game processing.

Though LSB steganography is described by way of example, without being limited thereto, the electronically watermarked game image can also be generated with another scheme.

According to the present example, information on the game processing is embedded in the game image by using electronic watermark, so that one who is able to read a watermark such as a developer of an application can know what kind of game processing has been performed based on the information embedded by watermark and can know a status of a game from the game image itself that can be observed with naked eyes. On the other hand, while information on the game processing is prevented from being read by one who is unable to read a watermark, difficulty in viewing the game image can be suppressed.

### [F. Process Flow]

A procedure of processing provided by execution of game program 17 according to the embodiment will be described. Each step is performed by execution of game program 17 by CPU 12.

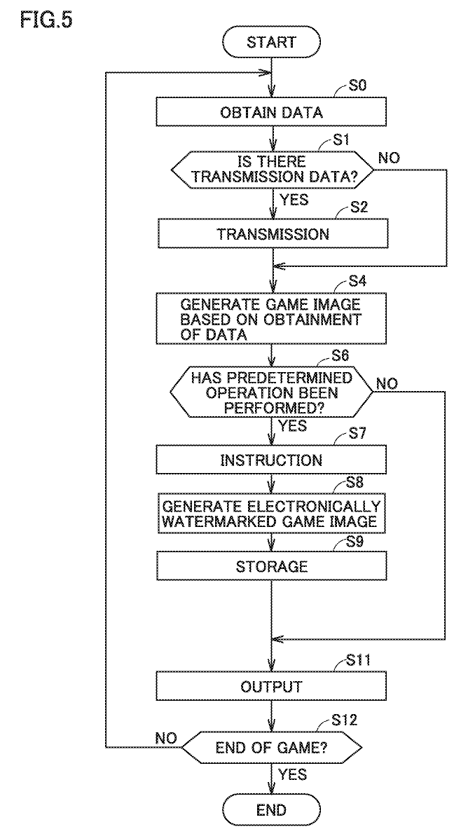

FIG. 5 is a flowchart illustrating processing in information processing apparatus 10A according to the embodiment.

Referring to FIG. 5, obtaining unit 200 obtains data (step S0). Specifically, obtaining unit 200 obtains operation data inputted by the user through input device 11, operation data from another user obtained through communication control unit 208, and the like.

Communication control unit 208 then determines whether or not there is transmission data (step S1). For example, communication control unit 208 determines whether or not there is operation data inputted by the user through input device 11.

When communication control unit 208 determines that there is transmission data (YES in step S1), it then transmits the transmission data to server 30. Server 30 receives the transmission data and transmits the information to another matched information processing apparatus 10. Thus, similar processing can be performed, for example, also in another information processing apparatus 10B.

When communication control unit 208 determines that there is no transmission data (NO in step S1), on the other hand, step S2 is skipped and processing therein is not performed.

Game processing performing unit 201 then generates a game image based on the operation data obtained by obtaining unit 200, the operation data from another user, and the like (step S4).

Storage instruction unit 204 then determines whether or not a predetermined operation has been performed (step S6). By way of example of the predetermined operation, an operation on a button for an instruction to perform a screenshot function will be described. Storage instruction unit 204 determines whether or not the button for the instruction to perform the screenshot function located at input device 11 has been pressed, as the predetermined operation by the user.

In step S6, when storage instruction unit 204 determines that the predetermined operation has been performed (YES in step S6), it gives an instruction to electronically-watermarked-image generator 206 (step S7).

Electronically-watermarked-image generator 206 then generates the electronically watermarked game image in accordance with the instruction (step S8).

Storage instruction unit 204 then has the generated electronically watermarked game image stored in storage 13 (step S9).

When storage instruction unit 204 determines in step S6 that the predetermined operation has not been performed (NO in step S6), on the other hand, steps S7 to S9 are skipped and processing therein is not performed.

Game processing performing unit 201 then outputs a generated image (step S11). Specifically, it outputs a game image based on the game processing or the electronically watermarked game image to display 14.

Game processing performing unit 201 then determines whether or not the game has ended (step S12).

When game processing performing unit 201 determines that the game has ended (YES in step S12), it quits the process (end).

When game processing performing unit 201 determines that the game has not ended (NO in step S12), on the other hand, the process returns to step S0 and is repeated.

In the present example, the process is repeated every predetermined cycle to perform the on-line competitive game processing.

An example where the electronically watermarked game image is transmitted to server 30 will now be described.

When communication control unit 208 accepts an instruction given by a predetermined operation by the user, it transmits the electronically watermarked game image stored in storage 13.

With a transmission function, the electronically watermarked game image stored in storage 13 is transmitted to server 30. In the present example, communication control unit 208 transmits the electronically watermarked game image stored in storage 13 to server 30 when a button for an instruction to perform the transmission function is pressed, by way of example of the predetermined operation by the user.

Though the example in which the button for the instruction to perform the transmission function is pressed is described in the present example by way of example, without being limited to pressing of the button, the transmission function may be performed, for example, by showing a menu in response to an operation by the user and selecting an item corresponding to the transmission function included in the menu.

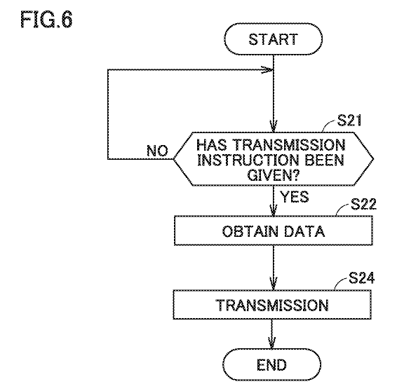

FIG. 6 is a flowchart illustrating transmission processing in information processing apparatus 10A according to the embodiment.

Referring to FIG. 6, communication control unit 208 determines whether or not a transmission instruction has been given (step S21). When communication control unit 208 determines in step S21 that the transmission instruction has not been given (NO in step S21), it maintains such a state.

The operation on the button for the instruction to perform the transmission function will be described as the transmission instruction by way of example. Communication control unit 208 determines whether or not the button for the instruction to perform the transmission function located at input device 11 has been pressed, as the predetermined operation by the user.

When communication control unit 208 determines that the transmission instruction has been given (YES in step S21), it then obtains the electronically watermarked game image from storage 13 (step S22).

Communication control unit 208 then transmits the obtained electronically watermarked game image (step S24).

Then, the process ends (end).

In an example where a plurality of electronically watermarked game images have been stored in storage 13, the plurality of electronically watermarked game images may collectively be transmitted to server 30 or electronically watermarked game image(s) selected by the user may be transmitted to server 30.

The electronically watermarked game image transmitted to server 30 is stored in storage 130. The electronically watermarked game image stored in storage 130 may be published such that a user or another user can access and view the electronically watermarked game image.

### (First Modification)

An example in which an electronically watermarked game image obtained by embedding information on game processing in a game image is generated and transmitted to server 30 is described in the embodiment above. In a present first modification, an example in which at least some of information on game processing is transmitted to server 30 without being embedded in a game image and information on the information transmitted to server 30 is embedded in the game image will be described.

Basic processing in the present first modification is substantially the same as that in the embodiment above, and processing different from that in the embodiment above will be described below.

In the present first modification, an identifier different each time game processing for an on-line competitive game is performed is issued, and information on the game processing and the identifier are transmitted to server 30 and stored therein in association with each other.

The information on the game processing transmitted to server 30 is, for example, information necessary for reproduction of the executed on-line competitive game or information that allows grasp of what kind of game processing has been performed. Specifically, the information includes operation data indicating an operation input, information on a parameter of a character operated by the user, or the like.

In transmission of the operation data indicating the operation input to server 30, time information may further be associated with the operation data. The time information is, for example, data indicating how long time has elapsed since start of the game processing for the on-line competitive game.

In response to an operation by the user, the electronically watermarked game image obtained by embedding the identifier in the game image by electronic watermark is generated.

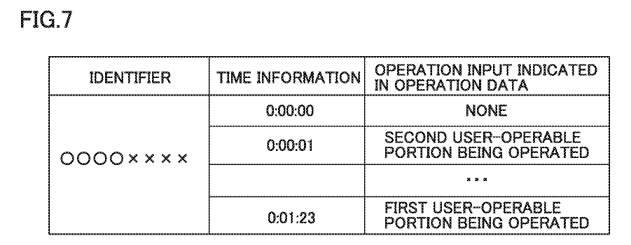

FIG. 7 is a diagram showing exemplary operation data associated with an identifier and time information, the operation data being transmitted to server 30.

Referring to FIG. 7, it is shown that a second user-operable portion is being operated at timing of lapse of one second since start of the game processing and that a first user-operable portion is being operated at timing of lapse of one minute and twenty-three seconds since start of the game processing.

Specifically, a person who is able to read a watermark can extract an identifier embedded in a game image. Furthermore, if that person is able to access server 30, he/she can obtain operation data associated with time information from server 30 based on the extracted identifier.

In the present first modification, information on the game processing not embedded in the game image can also be obtained from server 30.

Though an example in which information on the game processing is transmitted to server 30 without an operation by the user is described in the present first modification, information on the game processing may be transmitted to server 30 in response to the operation by the user.

Though information necessary for reproduction of the executed on-line competitive game or information that allows grasp of what kind of game processing has been performed is described as exemplary information on the game processing transmitted to server 30 in the present first modification, the information on the game processing transmitted to server 30 may be information larger in data amount than the identifier embedded in the game image.

### (Second Modification)

An example in which, in storing a game image with the screenshot function in accordance with an operation by the user, an electronically watermarked game image in which information on game processing is embedded by electronic watermark is generated and stored is described in the embodiment above.

In the present second modification, a scheme to always generate an electronically watermarked game image will be described.

For example, processing in step S6 in FIG. 5 for determining whether or not a predetermined operation has been performed is not provided.

According to the processing, the electronically watermarked game image may always be generated without the predetermined operation.

### (Additional Aspects)

Though the example in which the generated electronically watermarked game image is transmitted to server 30 is described above, the generated electronically watermarked game image may be transmitted to another server.

By way of example, another server refers to a server for a system or a service that allows sharing of an image or a server for a developer of an application. The electronically watermarked game image sent to the server for the developer of the application may be viewable only by the developer of the application.

Though the example in which the generated electronically watermarked game image is stored in storage 13 is described above, the generated electronically watermarked game image may be transmitted to server 30 and stored in server 30 without being stored in storage 13.

Though the example in which information for specifying a user, such as information on a user (player) ID or a serial number of the information processing apparatus main body, is not embedded is described above, such information may be embedded in the game image.

Though the example in which the operation data is embedded in the game image as the information on the game processing is described above, without being limited as such, information on a flag of game processing can also be embedded in the game image. By way of example of the flag, information on the flag as to whether or not a specific item is owned can be embedded. Alternatively, information on the flag as to change of ability without change of a parameter of a character, occurrence of change of which is not known from a game screen (increase in moving speed of a character or the like), can be embedded. Alternatively, information on the flag as to whether or not special ability (increase in distance of throw of an item by a character or the like) is provided can be embedded.

Though the example in which information on the game processing is embedded by electronic watermark in a still game image with the use of the screenshot function is described in the present example, the information on the game processing may be embedded by electronic watermark in moving images, without being limited to the still game image.

Information embedded every one frame may be variable (corresponding operation data may be embedded every frame), or in embedment of the identifier as in the first modification, information embedded every frame may be invariable.

The example in which an application side generates the electronically watermarked game image and has the electronically watermarked game image stored in storage 13 , in accordance with the button for the instruction to perform the screenshot function, is described in the present embodiment.

An operation system side, on the other hand, may generate the electronically watermarked game image and have the electronically watermarked game image stored in storage 13, in accordance with the button for the instruction to perform the screenshot function.

Specifically, the application side may generate the game image and pass the game image to the operation system (OS) and may pass also information on the game processing to the OS. The OS may generate a watermarked game image obtained by embedding information on the game processing in the game image, in accordance with the button for the instruction to perform the screenshot function.

The application may pass the information on the game processing in addition to the game image to the OS only when there is an operation on a button for the instruction to perform the screenshot function, or may pass the information on the game processing to the OS also in the absence of the operation on the button for the instruction to perform the screenshot function.

Though an embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. An information processing system comprising:
one or more processors; and
one or more memories storing instructions that when executed, cause the information processing system to perform operations including:
accepting an operation input from a player;
performing game processing corresponding to the accepted operation input; and
generating, for a game image based on the game processing, an electronically watermarked game image in which information on the game processing corresponding at least to the operation input is embedded by electronic watermark.

2. The information processing system according to claim 1, wherein
the information on the game processing does not comprise information that specifies the player.

3. The information processing system according to claim 1, further comprising:
a server; and
a communication unit configured to communicate with the server, wherein
the game processing comprises predetermined game processing associated with an identifier that is different each time the game processing is performed,
the generating the electronically watermarked game image generates, for a game image based on the predetermined game processing, an electronically watermarked game image in which the identifier is embedded by electronic watermark, and
the communication unit is configured to transmit information on the predetermined game processing corresponding to the identifier to the server.

4. The information processing system according to claim 3, wherein
information on the predetermined game processing comprises information for reproducing the predetermined game processing.

5. The information processing system according to claim 1, wherein
the information on the game processing corresponding to the operation input comprises information on the operation input from the player.

6. The information processing system according to claim 1, wherein
the information on the game processing corresponding to the operation input comprises at least one of information on a flag of the game processing, a seed value of the game processing, information to be used for determination as to collision of an object controlled in the game processing, and information on a memory of an apparatus configured to perform the game processing.

7. The information processing system according to claim 1, further comprising storing the electronically watermarked game image in accordance with a game image storage instruction given by the player, wherein
the generating the electronically watermarked game image
generates for the game image based on the game processing, when the game image storage instruction is given, the electronically watermarked game image in which the information on the game processing corresponding at least to the operation input is embedded by electronic watermark, and
does not generate for the game image based on the game processing, when the game image storage instruction is not given, the electronically watermarked game image in which the information on the game processing corresponding at least to the operation input is embedded by electronic watermark.

8. One or more non-transitory storage media having stored therein instructions that, when executed by one or more processors, cause a computer to perform operations comprising:
accepting an operation input from a player;
performing game processing corresponding to the accepted operation input; and
generating, for a game image based on the game processing, an electronically watermarked game image in which information on the game processing corresponding at least to the operation input is embedded by electronic watermark.

9. An information processing apparatus comprising:
accepting an operation input from a player;
performing game processing corresponding to the accepted operation input; and
generating, for a game image based on the game processing, an electronically watermarked game image in which information on the game processing corresponding at least to the operation input is embedded by electronic watermark.

10. A computer-implemented method comprising:
accepting an operation input from a player;
performing game processing corresponding to the accepted operation input; and
generating, for a game image based on the game processing, an electronically watermarked game image in which information on the game processing corresponding at least to the operation input is embedded by electronic watermark.
